(19) United States
(12) Patent Application Publication
(10) Pub. No.: US 2002/0162504 A1
(43) Pub. Date: Nov. 7, 2002

(54) Method for introducing and removing workpieces into or from a surface treatment area, a surface treatment device and an arrangement for surface treatment

(76) Inventor: Bernd Kreuzer, Lauterbach/Maar (DE)

Correspondence Address: Rocco S. Barrese, Esq., DILWORTH & BARRESE, LLP, 333 Earle Ovington Blvd., Uniondale, NY, 11553, US

(21) Appl. No.: 10/090,317

(22) Filed: Mar. 4, 2002

Related U.S. Application Data
(63) Continuation of application No. PCT/EP99/06493, filed on Sep. 3, 1999.

(51) Int. Cl. B05C 3/00

(52) U.S. Cl. 118/416; 118/423; 118/428

(57) ABSTRACT

The invention relates to a method for introducing and removing workpieces, especially vehicle bodies, into or from a treatment area (20) by rotational movements, whereby the treatment area serves for treating surfaces of the workpieces (1). A workpiece (1) is detachably fixed at a holding frame (2) which is moved together with at least one workpiece that is situated thereon at an essentially constant speed and by a continuous translation. The workpiece (1) is rotated around a rotational axle (6) at least at the beginning and end of the treatment area (20) and simultaneously with the translation movement. The rotational axle (6) is orientated vertically in relation to the moving direction of the holding frame (2) and is lifted and lowered during rotation.

### TECHNICAL FIELD

The invention relates to a method for introducing and removing workpieces, especially vehicle bodies, into or from a treatment area by means of an operation of introduction and removal, whereby said treatment area serves for treating the surfaces of the workpieces. According to the method, a workpiece is detachably fixed on a holding frame. The holding frame is moved together with the at least one workpiece that is situated thereon at an essentially constant speed by means of a continuous translation. The workpiece is rotated around a rotational axle at least at the beginning and the end of the treatment area and simultaneously with the translation movement, with the rotational axle being oriented vertically in relation to the moving direction of the holding frame. By the expression ‘at least at the beginning and the end’, those zones of the treatment areas are meant which are situated at the beginning and the end of a treatment basin, a treatment cabin, etc. It should be emphazised here that these zones could also extend up to the treatment areas and behind them. In addition, a rotation could also take place to a great extent within the treatment area.

The invention further relates to an apparatus for surface treatment of workpieces in one or more treatment areas with at least one holding frame for receiving one or a plurality of workpieces. The holding frame comprises a pick-up device by means of which the workpieces can detachably be fixed at the holding frame. Further, it has a rotational axle around which the holding frame can rotate. A holding frame guide device is provided in the apparatus which extends along one or several treatment areas and in which the holding frames can be moved in a guided manner. Furthermore, a rotary device is present for rotating the holding frame about its rotational axle. Further, a drive mechanism is provided by means of which the holding frame can be continuously translated within the holding frame guide device.

Finally, the invention relates to a system for surface treatment of workpieces having a plurality of subsequently arranged treatment areas. In the system, a plurality of holding frames are spaced apart from each other and movable by means of a continuous translation along the treatment areas. A feeding device is provided by means of which the workpieces can individually be supplied in accordance with the rotating velocity of the holding frames. In addition, a pick-up device is provided in one removal area of the system, by means of which the workpieces which have now been treated can be detached from the holding frames and transported away, with the holding frames further being continuously translated.

### PRIOR ART

A method, an apparatus and a system with the known features are known from WO 98/15359. In order to avoid unnecessary repetitions, reference to the disclosure of this international application is especially included in the present application. The cited publication already discloses rotational in and rotation out of workpieces, especially vehicle bodies, into or from a treatment area by means of superimposing a translational movement and a rotational movement. This superimposition of movements allowed for a first time to design the individual treatment areas to be shorter, since now the introduction and removal areas of a treatment area could be provided with vertical or almost vertical front walls. Due to a shortening of one treatment area, the overall length of the construction could now considerably be minimized also for a system having a plurality of subsequently arranged treatment areas, such as in particular a number of treatment baths arranged side by side. In principle, the advantages of a continuously conveying system have been combined for the first time with the advantages of a rotary device known from the prior art. It was found however that also these extremely advantageous embodiments according to the prior art could still be further improved.

### SUMMARY OF THE INVENTION

The technical problem underlying the invention consists in providing a method by means of which the introduction and removal of a workpiece into or from a treatment area can be optimised regarding the depth of the treatment area. Furthermore, the technical problem underlying the present invention is to provide an apparatus by means of which the method of the invention can be realized.

These technical problems are solved by a method comprising the features of claim 1, an apparatus comprising the features of claim 12 and a system comprising the features of claim 29. According to the invention, the method of the relevant category has been improved in that respect that the rotational axle is lifted and lowered during rotation. An apparatus according to the invention is characterized in that in the area at the beginning and at the end of the treatment area a rotational axle height adjustment is provided, by means of which the rotational axle can first be lifted and then lowered. Furthermore, the rotational axle device can be activated in the area of the rotational axle height adjustment. A system of to the initially mentioned kind comprises a plurality of such apparatus.

The invention is based on the conception to overlie the previous combined rotary and length movements of a workpiece a further translational movement, i.e. a translational movement which is aligned at an angle of 90° relative to the translational movement of the workpiece along the treatment area. By lowering and lifting the workpiece which is caused hereby during the rotary and forward movement, the necessary rotary radius and, thus, the depth of a treatment area can be reduced. The reduction according to depth is identical with the amount by which the rotational axle is lifted. According to an embodiment according to which a workpiece must be dipped into a treatment bath, e.g. a dip painting, the rotational axle is first lifted and then lowered. During this lifting and lowering the rotation also takes place. However, it should be pointed out here that in order to optimise the procedure, the rotation may also start before lifting or may end after lowering. In case a workpiece should be turned into a treatment area above the running path of the workpiece, such as into an enamelling cabin, the lowering of the rotational axle is performed first and thereafter the lifting.

In addition to the known advantages of a method according to the initially cited publication of the relevant category, the following advantages will result. As mentioned above, treatment areas having a reduced height (or depth) may be used which are easier to manufacture and to transport. In particular treatment baths may be produced at reduced cost. In addition to this, due to the low bath level, the pressure load in treatment baths is reduced so that these treatment baths may be designed for lower loads. This leads to reduced material cost and the production measures are more cost-advantageous. Due to the lower bath level at unchanged length and width of the treatment basin, the bath volume necessary to allow the workpiece to be completely dipped into the bath is reduced and less bath medium is required. As a result, this allows a considerable reduction of the necessary bath medium volume for greater systems. In addition to this, a cost-advantageous treatment of the workpieces becomes therewith possible. Corresponding to the reduced amount of bath medium, smaller counter-containers may be used particularly in pre-treatment systems and catalytic dip painting, which is again cost-saving. Due to the reduced bath volume less energy is required for transfer-pumping and heating the bath media. This represents also a considerable contribution to cost-reduction. The apparatus may be used as a substituent for the existing pendulum-type or overhead materials-handling technology. Already existing treatment baths or treatment tanks as well as the corresponding process technology may be further used. Previous systems according to the prior art initially mentioned may correspondingly be modified without greater expenditure.

According to an advantageous embodiment of the method according to the invention, the rotational axle is lifted until that point of the workpiece holding frame combination, which has the greatest distance to the rotational axle, is situated essentially vertically below the rotational axle. That point is understood by the expression ‘that point of the workpiece holding frame combination which has the greatest distance from the rotational axle’ which is spaced apart at the greatest distance in the direction of the translational lengthwise movement of the workpiece. This point namely defines the deepest dipping into the basin. If this point can be moved upwards by lifting the rotational axle, the depth of a treatment bath or the height of a cabin positioned above can be lowered accordingly.

As it was the case already regarding the prior art, it is extremely advantageous if the rotating velocity and the translational movement along the length are adapted in relation to each other when the workpiece is introduced into the treatment area such that the front part of the workpiece is positioned relative to a first front wall of the treatment area after the end of the rotation, whereby a predetermined clearance distance is considered. The clearance distance can be minimized here by the controlled rotational movement which is guided at any time. Therewith, the dipping of the workpiece into a treatment area is only reduced to the clearance distance, which particularly amounts e.g. to 0.1 to 1 m. In order to have the possibility to treat, for example, different vehicle bodies in a system, the clearance distance is adapted to the longest vehicle body.

In the operation of removing the workpiece, the advance of the workpiece to a second front wall is carried out until a determined clearance distance is reached which essentially corresponds to the first clearance distance. Thereafter, the removing operation is performed.

As is the case with the prior art, the rotational movement is in particular guided at all times in a controlled manner. This means that, the workpiece will not “fall down” or turn further around the rotational axle in an uncontrolled manner. It was established that it is extremely advantageous that the rotational axle follows a horizontal path distance during lifting which is identical with the horizontally travelled path distance during lowering. This allows the optimal use of the length of a treatment area. It is however, under certain circumstances, expedient that the rotational axle travels a shorter horizontal path distance during lifting as is the case during lowering, or vice versa. The latter means that the rotational axle moves a longer horizontal path distance during lifting than during the lowering operation.

It should further be noted here that under certain circumstances the procedures of introduction and removal may be performed under different angle ranges. If it is, for example, desired to transport the workpieces horizontally externally of the treatment area, the operation of introduction as well as removal will normally be performed approximately at 180°. A deviation therefrom could only be expedient if the workpiece would further be transported in the treatment area in an inclined position relative to the horizontal line. In case a workpiece should be transported in an inclined position at an angle amount, e.g. of from 10 to 300 externally of the treatment area, which is advantageous especially for dropping off treatment liquid, the operations of introduction and removal are performed at different angle ranges. The following are examples of this. A vehicle body is transported in an inclined position at 20° relative to the horizontal line in the direction of movement. In order to completely dip this vehicle body into a treatment bath, it is turned by approximately 160°. The vehicle body is therewith aligned overhead and horizontally in the treatment bath. In order to emerge from the bath, a turn of approximately 180 to 200° is performed. In the first case the vehicle body is transported further without inclination, in the second case it is again inclined at 20° relative to the horizontal line. In principle the same applies for an inclination of the vehicle body of 20° opposite to the direction of transport. However, in that case the operation of introduction is performed at an angle of approximately 200° and the operation of removal at an angle of approximately 160 to 180°. It is self-evident that the amounts of the angles change with the inclination selected.

As may be taken from the above-indicated examples, the operation of introduction and removal may also be performed in steps. Thus, it would be advantageous, especially for the transport of vehicle bodies, to provide the operation of removal in two steps. In this case, the vehicle body would initially only be turned at approximately 140 to 160°. Although the vehicle body is thereby removed from a treatment area, the vehicle body would however take up an inclined position whereby dropping off or flowing off of liquid is facilitated. The vehicle body would be further transported in this inclined position in horizontal direction to the next treatment area. After a predetermined dropping off time, a further turning would follow, so that finally the vehicle body would again be aligned in a horizontal direction. Depending on the conditions, the operation of introduction may also be provided in a plurality of steps. As a matter of course, the desired rotational position of the vehicle body (or, in general, the workpiece) in an apparatus according to the invention is at any time determined, that is, any position of the vehicle body relative to the horizontal line can be maintained along a desired path distance.

As was the case in the prior art, in the present invention the rotational axle of a holding frame is also continuously translated by a drive mechanism and the rotational movement of the rotational axle is induced by using this translational movement. Thus, in order to induce the rotational movement, no individual drive mechanism is required. However, it is self-evidently also possible to use a separate rotary device, e.g. an electric motor, on each holding frame.

According to a preferred embodiment, the rotational movement is induced by a lever system interacting with a stationary lever guide. The lever system is attached to the holding frame.

The rotational axle height adjustment in an apparatus according to the invention is advantageously formed by guide elements wherein the rotational axle of a holding frame is guided in a horizontal direction. The guide elements of a preferred embodiment run along the treatment area and have a rising guide element section and a descending guide element section at least in the area of introduction and removal of a treatment area, which is shown as an elevation. Thus, they are in principle designed in the form of a V. The transition from one leg of the V to the other is advantageously radiussed in order that a smooth transition is assured when changing the direction of the rotational axle, i.e. a rapid change of direction is avoided, if possible. With respect to construction, this may, for example be realized in that the two legs of the V are connected by partial arc of a circle, each tangentially osculating thereto. Further, it should be noted that the legs of the V could have different lengths and could thus also have different slopes, as has been described with respect to the horizontal path distances of the rotational axle covered.

If designed optimally, the guide elements are made in the form of rails and guide the end pieces of a rotational axle, so that the rotational axle performs a translational movement therein and can be moved according to a horizontal alignment. Such a design is technically simple, cost-advantagous, and in addition, robust.

As was the case with the prior art, in the present invention it is also preferred to continuously, translationally move the rotational axle of a holding frame by the drive mechanism. Using this translational movement, it is additionally possible to induce the rotational movement of the rotational axle. This may, for example, be done by a rack-pinion combination, but also by a lever system attached to the holding frame which engages with a stationary lever guide. As compared with the rack-pinion combination, the lever system has the advantage that the large momentum required for large and heavy workpieces, such as vehicle bodies, may be generated by simple, longer lever arms.

The rotational movement will in particular constantly be guided, if at least one lever is present as a holding frame which is fastened to one side and interacts with the lever guide. In particular, two levers are non-rotatably connected and offset relative to each other at a predetermined amount of an angle, e.g. 90°. This assures that also in case the lever guide has an extremely simple design, one lever is always in engagement during the rotational movement as well as during the translational movement. Thus, any uncontrolled turning of the holding frame around the rotational axle is at any time avoided.

A very simple embodiment provides that guide surfaces have rising and descending guide sections and which serve as a lever guide.

A system according to the invention is characterized in that a plurality of subsequently arranged treatment areas are present, each equipped with an apparatus according to the present invention.

### SHORT DESCRIPTION OF THE DRAWINGS

In the following, a plurality of embodiments are shown with reference to the accompanying drawings for further explanation and for a better understanding, wherein:

FIG. 1 shows a diagrammatic side view of an apparatus of the invention having liftable rotational axles and a drive transmission onto a holding frame through an articulated rod according to a first embodiment,

FIG. 2 shows a perspective side view of an apparatus according to FIG. 1 and

FIG. 3 shows a diagrammatic side view of an apparatus of the invention having liftable rotational axles and a drive transmission to a holding frame directly by means of drive chains.

### DESCRIPTION OF PREFERRED EMBODIMENTS

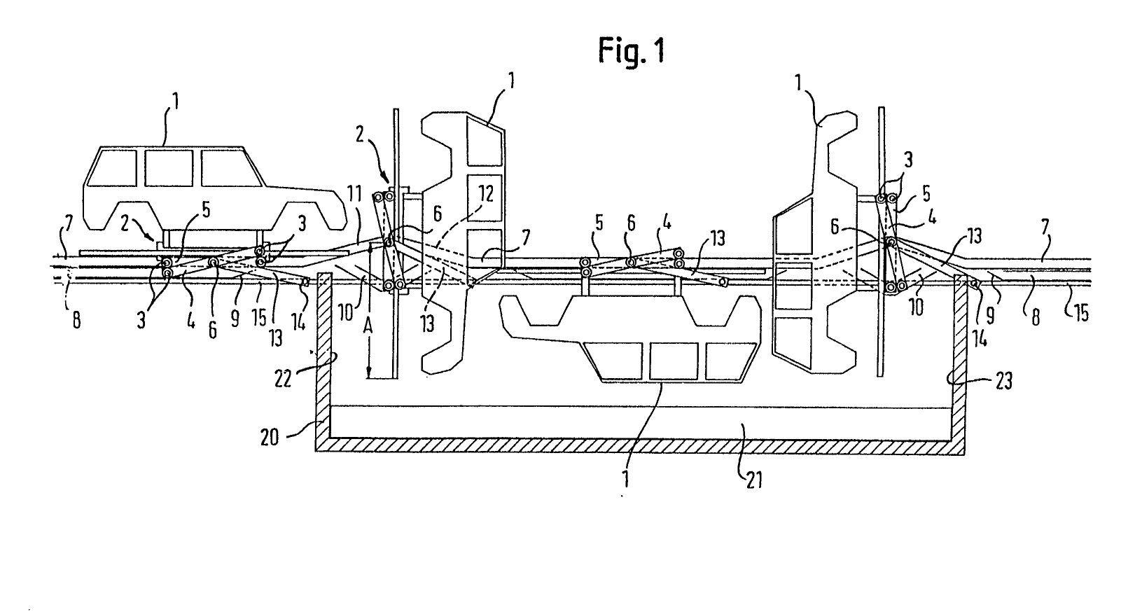

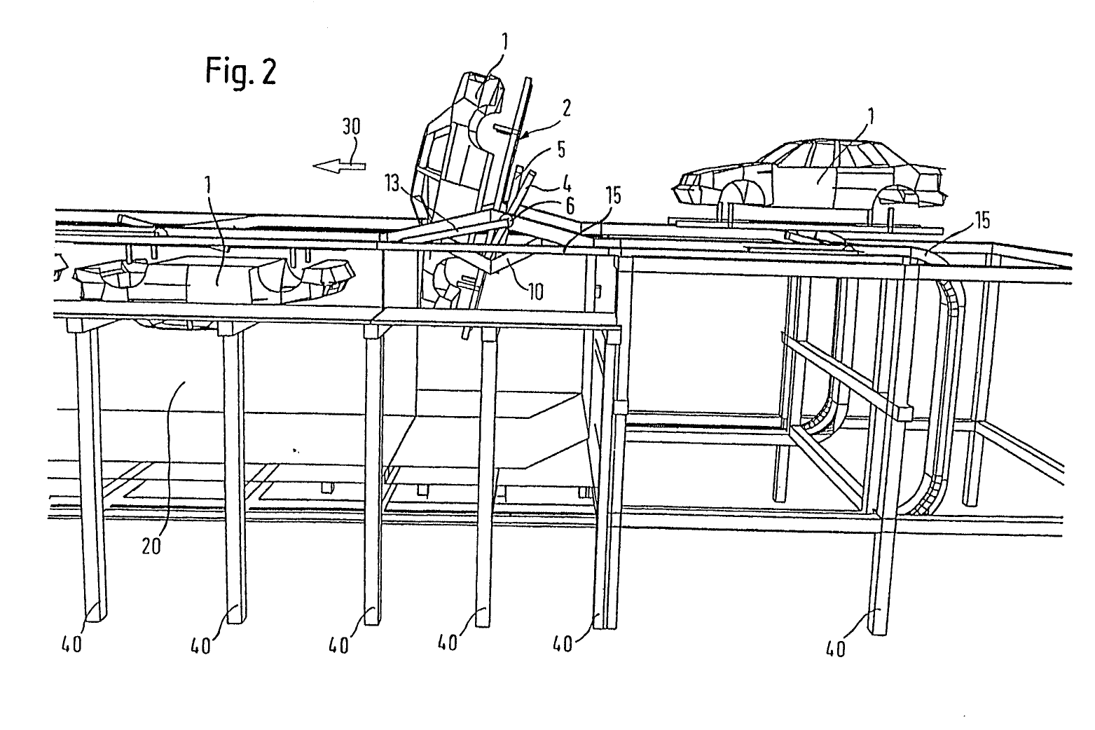

In the following, a first embodiment of the invention is explained in more detail with reference to FIGS. 1 and 2. As is shown in the views of FIGS. 1 and 2, a rotational axle guide 7 runs above a treatment bath 20 in lengthwise direction thereof. The rotational axle guide 7 consists of two rails running in parallel to each other which are spaced from each other and extend along the two longitudinal sides of the treatment bath. In these rails of the rotational axle guide 7, a rotational axle 6 of a holding frame 2 for a vehicle body 1 is supported for translational movement.

A holding frame 2 comprises a pick-up device which is not shown in detail, by means of which a vehicle body is detachably fastened to a holding frame 2. The pick-up device is known per se and may be designed in most different ways, for example as a hook, a clamping device, etc. At one long side a holding frame 2 is further equipped with two levers 4, 5 which are offset from each other at a certain angle amount. Both levers 4, 5 are non-rotatably connected to the rotational axle 6. Rolls 5 are attached to the ends of the levers 4, 5 by means of which the levers 4 run in a lever guide 8.

In the present embodiment, the lever guide 8 extends below the rotational axle guide 7, it could however also be arranged laterally or above the rotational axle guide 7. Due to the straightly extending sections of the lever guide 8 a holding frame 2 is moved horizontally aligned at constant speed and by means of a continuous translation via the levers 4, 5. In front of a first front wall 22 of the treatment bath 20 the lever guide 8 has an upwardly inclined guide surface 9. In addition, V-shaped sections 10 of the lever guide 8 are provided at the beginning and the end of a treatment bath 20.

The rotational axle guide 7 further comprises rising and descending guide sections 11, 12. By means of these guide sections 11, 12 the rotational axle 6 of a holding frame is upwardly offset by a vertical distance. The highest point of the rising and descending guide sections 11, 12 of the rotational axle guide 7 is situated above the deepest point of the V-shaped lever guide sections 8.

Two endless drive chains run spaced apart from each other in corresponding drive chain guides 15 below the lever guide 8. Rotational axles 6 of a holding frame 2 are rotatably attached to the drive chains by means of articulated rods 13 and hinges 14. This embodiment, in which the chain guide 15 is separated from the rotational axle guide 7, is preferred as compared to the embodiment which is described in the following, in which these two guides are combined, since the lifetime of the endless chains and of the parts coming in contact therewith is longer if the chains are not subjected to substantial reversals, which is the case with the other embodiment. However, the embodiment comprising the combined guides has the advantage of being structurally less complex.

In the following, the operation of such an apparatus is described in more detail. The holding frames 2 are moved in the rotational axle guide 7 at constant speed and by means of a continuous translation by the operation of the drive chains. As soon as a roll 5 of a lever arm 4 of the holding frame 2 runs onto the raising flank 9 of the lever guide 8, the holding frame 2 will be rotated. By the further translational movement through the drive chains, the translational movement is superimposed on this rotational movement. The V-shaped section 10 in the rotational lever guide 8 is designed such that at least one of the levers 4, 5 with the accompanying roll 5 runs hereinto, so that the rotational movement is continuously guided thereby. During this combined rotational movement and translational movement the rotational axle 6, and, together therewith, the complete holding frame 2 is now lifted within the raising sections 11 of the rotational axle height adjustment. The rotational movement continues during lifting. The highest point is reached when the distance A, i.e. the greater distance of the holding frame 2 or the vehicle body 1 from the rotational axle 6, lies below the rotational axle. Then the holding frame 2 is again lowered along the descending section 12 of the rotational axle height adjustment, with the rotational movement being continuously performed along the V-shaped sections 10 of the lever guide 8. The upwards deflection of the rotational axle 6 or the holding frame 2 in the rotational axle guide 7 is compensated by the rotational axle 6 via the articulated rod 13 and the hinged construction and by the drive chain in the accompanying drive chain guide 15 via the hinge 14.

As soon as the vehicle body 1 is dipped completely into the treatment bath, the rotational movement ends and the levers 4, 5 again run in the straight rotational lever guide 8. The removing operation at the end of the treatment bath 20 is carried out in the same way as the introduction operation, the rotational axle is again lifted under simultaneous rotation and finally again lowered. The rotation is carried out in the same direction as during the introduction operation.

From FIG. 1 may be taken that there is no need for a depth area 21 due to the rotational axle height adjustment 11, 12. The depth area of the treatment bath 20 which is actually required is therewith smaller by the height of the depth area 21, as is the case with the prior art. Also the depth area 21 to be done without can thus be controlled via the vertical height change of the rotational axle 2 by means of the rotational axle height adjustment 11, 12. The revolving guide of the drive chain 15 and the rotational axle guides 7 may particularly be taken from FIG. 2. It may also be recognized therefrom that the whole system rests on supports 40 with the individual treatment baths 20 being arranged thereinbetween. In this Figure, the translational movement of the vehicle bodies is designated by the reference numeral 30.

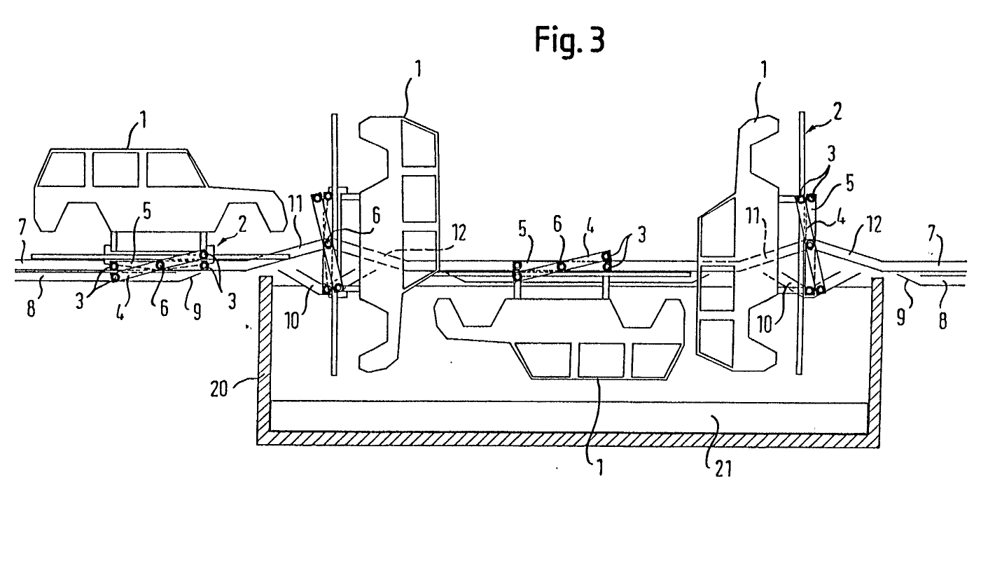

A second embodiment of the apparatus of the invention may be taken from the diagrammatic side view of an apparatus of the invention in FIG. 3. This embodiment corresponds to a large extent to the first embodiment according to FIGS. 1 and 2. In the present embodiment, there is however no separate drive chain guide 15, yet the drive chain is integrated in the rotational axle guide 7. There is thus not need for the articulated rods 13. Thus, in this embodiment, the holding frames 2 with the rotational axles 6 are directly rotatably attached to drive chains in the rotational axle guide 7 which are not shown here.

Apart therefrom, this second embodiment of the invention functions in the same way as the first embodiment, so that in this respect reference is made to the description above, in order to avoid unnecessary repetitions.

1. Method for introducing and removing workpieces, especially vehicle bodies, into or from a treatment area (29), whereby said treatment area serves for treating the surfaces of the workpieces (1) by an introduction operation or a removal operation, wherein
at least one workpiece (1) is detachachably fixed at a holding frame (2),
the holding frame (2) is moved together with the at least one workpiece (1) that is situated thereon at an essentially constant speed and by means of a continuous translation,
the workpiece (1) is rotated around a rotational axle at least at the beginning and the end of the treatment area (20) and simultaneously with the translational movement, with the rotational axle being oriented vertically in relation to the moving direction of the holding frame (2),
characterized in that
the rotational axle (6) is lifted and lowered during rotation.

2. Method according to claim 1,
characterized in that
the rotational axle (6) is lifted until that point of the workpiece-holding frame combination (1, 2) which has the greatest distance (A) to the rotational axle (6) and which is positioned essentially vertically below the rotational axle (6).

3. Method according to claim 1 or 2,
characterized in that
when the workpiece (1) is introduced in the treatment area (20), the rotating velocity and the velocity of translational movement are adapted to each other such that the front part of the workpiece (1), after completion of the operation of rotation under consideration of a predetermined clearance distance, is positioned relative to a first front wall (22) of the treatment area (20).

4. Method according to claim 1,
characterized in that
the operation of removal of the workpiece (1) from the treatment area (20) is started when the front part of the workpiece (1) has reached a predetermined clearance distance to a second front wall (23) of the treatment area (20), and during the removal operation the rotating velocity and the velocity of the translational movement are adapted relative to each other such that the workpiece is again horizontally aligned when the rotational operation is completed.

5. Method according to claim 1 or 2,
characterized in that
the rotational operation is at all times guided in a controlled manner.

6. method according to claim 1 or 2,
characterized in that
the rotational axle (6) runs during lifting along a horizontal path distance which is identical with the horizontal path distance covered during lowering.

7. Method according to claim 1 or 2,
characterized in that
the rotational axle (6) runs during lifting a shorter horizontal path distance then during lowering.

8. Method according to claim 1 or 2,
characterized in that
the rotational axle (6) runs during lifting a longer horizontal path distance then during lowering.

9. Method according to any of claims 1, 6, 7 or 8,
characterized in that
the lifting and the lowering of the rotational axle (6) is predetermined by raising and descending guide elements (11, 12) wherein the rotational axle (6) of a holding frame (2) is guided.

10. Method according to claim 1,
characterized in that
the rotational axle (6) of a holding frame (2) is subjected to a continuous translational movement by a drive mechanism, and the rotational movement of the rotational axle is induced by utilizing this translational movement.

11. Method according to claim 10,
characterized in that
the rotational movement of the rotational axle (6) is induced by a lever system (4, 5) fastened to the holding frame (2) and guided in a stationary lever guide (8, 9, 10).

12. Apparatus for surface treatment of workpieces (1) in one or a plurality of treatment areas (20), in particular for surface treatment of vehicle bodies in treatment baths or treatment cabins, including
at least a holding frame (2) for picking-up one or a plurality of workpieces (1) which comprises:
a pick-up device by means of which the workpiece (1) is detachably fixable to the holding frame (2), and
a rotational axle (6) around which the holding frame (2) is rotatable,
a holding frame guide device (7) which extends along the one or a plurality of treatment areas (20) and wherein the holding frames (2) are movable in a guided manner,
a rotary device (8, 9, 10) for rotating the holding frame (2) around its rotational axle (6),
a drive mechanism by which the holding frame (2) is movable in the holding frame guide device (7) by means of a continuous translation,
characterized in that
one rotational axle height adjustment (11, 12) each is provided at least in the area of introduction and removal of the treatment area (20), by means of which the rotational axle (6) of a holding frame (2) can be lifted and lowered, and
the rotary device (8, 9, 10) in the area of the rotational axle height adjustment (11, 12) can be activated.

13. Apparatus according to claim 12,
characterized in that
the rotational axle height adjustment (11, 12) for lifting and lowering the rotational axle (6) of a holding frame (2) is designed such that the rotational axle (6) reaches its highest point when that point of the workpiece-holding frame combination (1, 2), which has the greatest distance (A) to the rotational axle (6), is situated essentially vertically below the rotational axle (6).

14. Apparatus according to claim 12 or 13
characterized in that
the rotary device (8, 9, 10) and the drive mechanism (15) are designed such that the rotating velocity and the velocity of the translational movement are adapted to each other such that the front part of the workpiece (1) after completion of the operation of rotation under consideration of a predetermined clearance distance is positioned relative to a first front wall (22) of the treatment area (20) when the workpiece (1) is introduced in the treatment area (20).

15. Apparatus according to claim 14,
characterized in that
the rotary device (8, 9, 10) can be activated and the removal of the workpiece (1) begun when the front part of the workpiece (1) has reached a predetermined clearance distance to a second front wall (23) of the treatment area (20), and
the rotary device (8, 9, 10) is designed such that its rotating velocity is adapted to the velocity of the translational movement predetermined by the drive mechanism (15) such that the workpiece (1) is again horizontally aligned when the rotational operation is completed.

16. Apparatus according to any of claims 12 to 15,
characterized in that
the rotational axle height adjustment (11, 12) is designed such that the rotational axle (6) runs during lifting along a horizontal path distance which is identical with the horizontal path distance covered during lowering.

17. Apparatus according to any of claims 12 to 15,
characterized in that
the rotational axle height adjustment (11, 12) is designed such that the rotational axle (6) runs during lifting a shorter horizontal path distance then during lowering.

18. Apparatus according to any of claims 12 to 15,
characterized in that
the rotational axle height adjustment (11, 12) is designed such that the rotational axle (6) runs during lifting a longer horizontal path distance then during lowering.

19. Apparatus according to any of claims 12 to 18,
characterized in that
the rotational axle height adjustment (11, 12) is formed by guide elements (7, 11, 12), wherein the rotational axle (6) of a holding frame (2) is guided in a horizontally aligned manner.

20. Apparatus according to claim 19,
characterized in that
the guide elements (7, 11, 12) run lengthwise the treatment areas (20) and each of said guide elements has a rising guide element section (11) and a descending guide element section (12) in the introduction and removal area of a treatment area (20), when looked at it in a side view.

21. Apparatus according to claim 19 or 20,
characterized in that
the guide elements run lengthwise the treatment areas (20) and are designed as rails (11, 12), wherein the end parts of a rotational axle (6) are guided by means of a translational movement.

22. Apparatus according to claim 12,
characterized in that
the rotational axle (6) of a holding frame (2) can be moved in a continuous translation by means of the drive mechanism (15) and the rotational movement of the rotational axle (6) can be induced by utilizing this translational movement.

23. Apparatus according to claim 12 or 22,
characterized in that
a lever system (4, 5) is provided, which is attached to the holding frame (2) and guided in a stationary lever guide (8, 9, 10), by means of which the rotational movement can be induced.

24. Apparatus according to claim 12 or 23,
characterized in that
the holding frame (2) has at least a laterally attached lever (4, 5) which interacts with a lever guide (8, 9, 10) to effect the rotation of the holding frame (2).

25. Apparatus according to claim 12 or 24,
characterized in that
two levers (4, 5) are non-rotatably connected to the rotational axle (6) and are offset by a predetermined angle amount relative to each other.

26. Apparatus according to one of claims 12, 23, 24 or 25,
characterized in that
two levers are arranged on each side of the holding frame with the levers each being arranged on one side of the holding frame (2).

27. Apparatus according to any of claims 22 to 26,
characterized in that
the lever guide (8) has suitable guide surfaces (9, 10) in the area of introduction or removal of a treatment area (20) for rotating the holding frame (2).

28. Apparatus according to claim 27,
characterized in that
the guide surfaces have raising and descending guide sections (10).

29. System for surface treatment of workpieces, especially vehicle bodies, comprising:
a plurality of subsequently arranged treatment areas (20),
an apparatus according to one or a plurality of claims 12 to 28 having a plurality of holding frames (2), which are spaced from each other and are movable by means of a continuous translation along the treatment areas (20),
a feeding device by means of which the workpieces can be individually fed in accordance with the rotating velocity of the holding frames (2), and
a pick-up device by means of which the workpieces (1) which have now been treated can be detached from the holding frames (2) and transported away during continuous movement of the holding frames (2) in a removal area of the system.

30. System according to claim 29,
characterized in that
the holding frames (2) above, below or laterally from the treatment areas (20) can be transported back from the removal area to the introduction area of the system.

31. System according to claim 29 or 30,
characterized in that
the rotational axle guides (8) are arranged above and below the treatment areas (20) and designed in the form of endless rotating deflection devices and situated in the area of introduction and removal of the system.
